(19) United States
(12) Patent Application Publication
(10) Pub. No.: US 2026/0337103 A1
(43) Pub. Date: Oct. 29, 2026

(54) Carbon-Absorbing Concrete and Method of Production

(71) Applicant: Michael Lafave, Denver, CO (US)

(72) Inventor: Michael Lafave, Denver, CO (US)

(21) Appl. No.: 18/722,678

(22) PCT Filed: Feb. 1, 2024
(86) PCT No.: PCT/US2024/013913

§ 371 Date: Jun. 21, 2024

Related U.S. Application Data
(60) Provisional application No. 63/469,108, filed on May 26, 2023.

(51) Int. Cl. C04B 28/00; B01D 53/62; B01D 53/82; C04B 14/06; C04B 14/10; C04B 16/02; C04B 18/14; C04B 22/10; C04B 111/00; E01C 7/14

(52) U.S. Cl. CPC C04B 28/006; B01D 53/62; B01D 53/82; C04B 14/06; C04B 14/106; C04B 16/02; C04B 18/141; C04B 22/10; E01C 7/142; B01D 2251/402; B01D 2251/404; B01D 2257/504; B01D 2258/06; C04B 2111/00019; C04B 2111/0075

(57) ABSTRACT

A carbon-sequestering geopolymer concrete composition and method of manufacture is disclosed. The composition comprises a geopolymeric binder phase of aluminosilicate materials and an alkaline activator, coarse and fine aggregates, dried marine algae powder, and optional supplementary cementitious materials. This enables significantly reduced carbon dioxide emissions during production compared to standard concrete mixes. Additionally, the integrated algae powder facilitates direct capture and mineralization of atmospheric carbon dioxide as the concrete cures.

Aspects of embodiments of the invention include the concrete composition; a sidewalk embodiment comprising said concrete; associated sidewalk construction methods; and alternate sidewalk embodiment claims. Compared to conventional concretes, the technology disclosed herein provides over 70% lower CO2 emissions coupled with enhanced carbon mineralization that progresses over the material lifetime. This enables various infrastructure applications to reach carbon-absorbing or carbon-negative performance credentials. The composition also exhibits excellent mechanical strength, freeze-thaw resilience, and extended durability properties.

### BACKGROUND OF THE INVENTION

Annually, over 4 billion metric tons of conventional Portland cement concrete are produced globally, making it the world's most consumed material after water. However, manufacturing the Portland cement binder alone accounts for 7-8% of all carbon dioxide emissions worldwide. This represents an immense environmental burden directly tied to concrete usage across buildings, infrastructure and construction, generating over 2 gigatons of carbon dioxide (CO2) per year during cement production. Mitigating these enormous emissions by creating concrete that can actively absorb and mineralize atmospheric carbon has emerged as a promising climate change mitigation strategy. Recent advances have attempted to enable CO2 sequestration in concrete by incorporating seawater at various steps of the mixing process before curing. Seawater contains dissolved calcium, magnesium, and carbonates that can bond with absorbed CO2 to form stable carbonates. However, existing seawater approaches have achieved only modest, inconsistent levels of CO2 absorption that pale in comparison to the scale of emissions from concrete production. Substantial challenges remain in translating proof-of-concept carbon-absorbing concrete methods into commercially viable, scalable solutions for the $300 billion per year concrete industry. Major limitations on supply logistics, absorption kinetics, and mineral delivery continue to restrict widespread adoption of carbon-absorbing concrete technology.

For example, the concrete volumes required to build a typical high-rise tower can generate over 150,000 tons of CO2 emissions solely from the concrete production. Additionally, a typical 4-lane highway stretching 1 mile long requires 25 million lbs. of concrete, indirectly emitting around 24 million lbs. of CO2 through its binder manufacturing. Sidewalk construction further substantially exacerbates emissions.

Beyond just the greenhouse gas impacts, conventional concrete also creates problems related to the raw materials needed in production. Harvesting the limestone, clay and shale used to make Portland cement contributes to depletion of finite natural resources and landscape damage. The lifecycle threats also extend to end-of-life, whereby spent traditional concrete often ends up in landfills without efficient recycling pathways currently available.

There is a substantial need within the construction sphere to mitigate the considerable sustainability issues tied to conventional concrete across all its major application areas. Achieving global emissions reductions targets requires transformative technologies to curb the environmental burdens created by buildings, roads and civic structures historically reliant on standard Portland cement-based concrete mixes.

A major compatibility issue arises when attempting to integrate existing CO2 absorption approaches into standard concrete manufacturing using Portland cement. Portland cement relies on carbonation reactions during curing, which interfere and compete with the additional CO2 absorption mechanisms. The calcium silicates in Portland cement undergo hydration and hardening reactions that release calcium ions, hydroxide ions, and heat. Therefore there remains a need for an improved solution.

The incorporation of Portland cement competes directly with the CO2 absorbing properties associated with the setting of the concrete matrix. The interdependent chemical interactions with Portland cement chemistry make it challenging to achieve consistent, reliable CO2 sequestration. The varying conditions also cause wide fluctuations in total carbon absorption from one batch to another. This cement incompatibility remains a major unresolved barrier for adoption of existing carbon-absorbing techniques on an industrial scale using standard Portland cement-based concrete mixes. Concrete production using Portland cement in general remains a major contributor to CO2 emissions. It is estimated that for a typical 30-story building, approximately 160,000,000 lbs. of CO2 are released just from the concrete required, calculated based on approximately 158.8 million lbs. of concrete needed.

A major drawback of prior art approaches associated with CO2 sequestering concrete that utilize seawater for CO2 absorption is the substantial transportation costs and logistical barriers associated with obtaining and delivering large volumes of seawater to inland construction sites. Seawater has relatively low concentrations of the reactive minerals needed for meaningful CO2 sequestration. Typical seawater is only about 3.5% dissolved salts by weight, requiring extremely large quantities of water to contribute enough calcium, magnesium, and other minerals to enable adequate carbon dioxide absorption as the concrete cures. Transporting such enormous volumes of seawater hundreds or thousands of miles inland from coastal areas would require specialized containers and trucks as well as significant fuel for delivery. Even with costly transportation infrastructure, the supply and rate of deliveries may be insufficient to support high volume concrete pours. Additionally, most concrete batch plants do not have existing infrastructure to unload, store, and process such large water volumes on site. These transportation and logistics constraints impose major economic and operational limitations for adopting seawater-based carbon absorption approaches in commercial ready mix concrete production, especially for construction projects far from the coastline.

Another significant challenge with existing seawater-based techniques for CO2-absorbing concrete is the slow speed and low efficiency of carbon dioxide absorption. Seawater relies on natural diffusion of CO2 gas molecules into stagnant microscopic water pockets dispersed within the concrete matrix. However, the rate of diffusion is extremely slow compared to the chemical bonding potential of reactive mineral ions. This disparity in absorption speed versus bonding speed during curing severely limits the overall CO2 uptake capacity. There is an abundance of dissolved calcium, magnesium, and other minerals in seawater that could chemically bind large amounts of CO2 if the gas could access and react with the ions. But the slow, uncontrolled diffusion process restricts absorption of CO2 to levels far below what could be achieved with faster kinetics. Consequently, existing seawater-based approaches fail to fully leverage the CO2 absorption potential of the seawater salts, restricting their carbon uptake and negation capabilities.

Attempts have also been made to utilize freshwater algae for CO2 sequestration in concrete, but these have achieved limited success. Freshwater algae lack many of the cellular adaptations that enable marine saltwater algae to be highly effective carbon sinks. Marine saltwater environments require algae to evolve robust cell walls with concentrated salts and carbon-binding structures tuned for ocean conditions. Freshwater species do not face the same selective pressures, so their cell walls are relatively fragile and have lower innate CO2 affinity. As a result, freshwater algae release fewer reactive minerals and absorb markedly less CO2 upon rehydration in curing concrete when compared to marine algae. The far lower performance coupled with supply constraints from freshwater algae farming make these unsuitable for scalable, high-efficiency CO2 sequestration in concrete.

In summary, while incorporating seawater and algae into concrete mixes shows some promise for enabling CO2 mineralization, existing approaches have severe limitations that prevent widespread commercial adoption. Major compatibility issues arise when attempting to integrate current seawater and algae CO2 absorption techniques with standard concrete manufacturing using Portland cement. Additionally, substantial logistics barriers exist for obtaining the large volumes of seawater needed. And the slow seawater diffusion kinetics restrict overall CO2 uptake rates and capacity. These deficiencies result in inconsistent, modest levels of carbon absorption that are dwarfed by the scale of emissions from industrial concrete production. Therefore, there remains a need for an improved invention that can enhance CO2 sequestration within concrete while overcoming the transport, reactivity, and cement compatibility challenges that continue to restrict the viability of existing methods. Such an invention could provide a scalable pathway to transforming a major CO2 emission source into a carbon sink, enabling broader adoption of eco-friendly construction materials with a reduced carbon footprint.

### SUMMARY OF THE INVENTION

The preferred embodiment of the invention transforms conventional carbon-emitting concrete into an eco-friendly construction material that actively absorbs carbon dioxide from the air. It leverages a novel composition and manufacturing method to reduce the carbon footprint of concrete in two ways-by curtailing emissions from production and enabling direct CO2 removal during curing of the concrete.

In association with the preferred embodiment, rather than using traditional Portland cement, the disclosed concrete composition 100 and associated methods of manufacture utilize industrial byproducts known as geopolymers, such as slag and fly ash, as the primary binder. The use of these waste materials not only reduces landfill loading, but also decreases CO2 emissions from cement production by up to 80%. To enable renewable post-installation carbon absorption, the novel mixture also incorporates dried marine saltwater algae powder in association with the preferred embodiment. As the concrete cures, the dried algae rehydrates and reacts with atmospheric CO2 through natural mineralization processes optimized for high uptake capacity.

The environmental benefits associated with the disclosed embodiments are numerous. For example, in association with prior art technologies, for a typical 30-story building, approximately 160 million pounds of carbon dioxide are released just from the required concrete using regular Portland cement. In contrast, the use of geopolymer binders in association with the preferred embodiment invention would curb over 127 million pounds of those emissions for the same building. Additionally, the integrated marine saltwater algae associated with the preferred embodiment further actively absorbs significant amounts of CO2 as the concrete cures. Taken together, these dual carbon impact mechanisms associated with the embodiments disclosed herein could reduce the net CO2 emissions as compared to the prior art by over 80%.

### BRIEF DESCRIPTION OF THE FIGURES

FIG. 1 depicts the usage of an embodiment of the invention in association with a sidewalk.

FIG. 2 depicts the usage of an embodiment of the invention in association with a pillar associated with a typical construction project.

### DETAILED DESCRIPTION

The present invention relates to a carbon-sequestering concrete composition 100 comprising a geopolymeric binder phase and an algae additive for enhanced carbon mineralization. The concrete is formed by combining algae biomass that has been dried and pulverized into a fine powder with a geopolymer precursor to produce a binder phase. Suitable geopolymer precursors include aluminosilicate materials such as fly ash, slag, metakaolin, or natural minerals rich in alkali metals. These are combined with an alkaline activator solution to induce geopolymerization reactions. The algae powder is then incorporated into this geopolymeric binder phase along with coarse and fine aggregates before curing. Through both the reduced reliance on traditional Portland cement and the inclusion of the carbon-mineralizing algal biomass, the disclosed concrete system exhibits significantly lower carbon footprints compared to conventional concretes. The composition also demonstrates excellent mechanical strength and durability properties for infrastructure and construction applications.

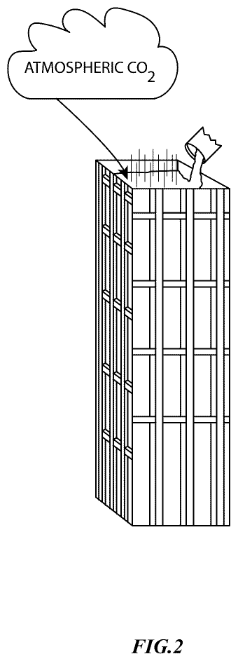

The carbon-sequestering geopolymer-algae concrete has particular utility for sustainable buildings, transportation infrastructure, and public works projects seeking to minimize environmental impacts from construction, including by the utilization of the concrete composition 100 in association with pillars associated with such projects as depicted in FIG. 2.

High-performance structures can be erected using the present invention as the primary concrete for foundations, floors, walls and other load-bearing elements with enhanced durability compared to traditional mixes. For example, high-rise towers, commercial buildings, residential units and mixed-use developments can reduce their carbon footprint by over 70% using the disclosed concrete technology. Additionally, implementing the composition for roads, bridges, alleyways, sidewalks and parking garages facilitates improved lifecycle performance across civic construction initiatives. The present invention thereby enables the built environment's two largest consumers of concrete—buildings and infrastructure—to meaningfully curtail greenhouse emissions associated with critical urban growth and renewal efforts through adoption of the carbon-mineralizing geopolymer-algae concrete in their projects.

### Composition

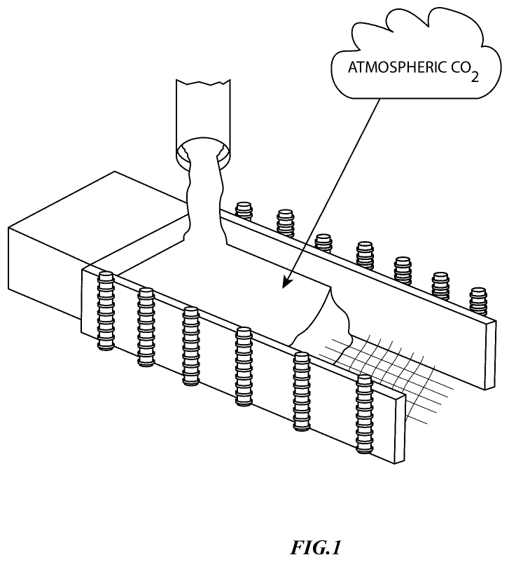

The disclosed carbon-absorbing geopolymer concrete leverages a specialized composition designed to reduce the carbon footprint of concrete structures, such as those depicted in FIGS. 1 and 2. It replaces traditional carbon-intensive Portland cement with industrial byproducts known as geopolymers. These geopolymers serve as the main binder to hold together concrete constituents and cure into a strong, durable matrix. The composition also incorporates dried marine algae powder, which enables the concrete to directly capture and mineralize carbon dioxide from the air as it cures.

In association with various embodiments, the carbon-absorbing geopolymer concrete 100 has the following composition by weight:
35-50% geopolymers
30-45% sand
15-25% coarse aggregates, such as gravel or crushed stone
5-10% water
1-5% dried marine saltwater algae powder

### Geopolymer Aspects

The use of industrial byproducts as geopolymer precursors reduces CO2 emissions from cement production, while the integrated marine algae powder imparts carbon mineralization functionality to the concrete 100 for additional emissions offsetting.

The disclosed carbon-absorbing concrete achieves significant environmental benefits by incorporating industrial byproducts, known as geopolymers, to largely replace traditional Portland cement. Geopolymers suitable for use as primary binders include materials such as slag, fly ash, and silica fume. These are waste products resulting from various manufacturing processes involving high heat, including iron production, coal combustion, and silicon alloying. In association with the preferred embodiment of the concrete mix, the slag comprises 30-50% of the total mix material. The remainder of the mix material comprises 30-40% gravel, approximately 35% sand, 2-5% of algae-based additives, 5-10% magnesium oxide, 5-10% calcium oxide, and approximately 10% of alkali activator. The alkali activator is comprised of approximately half sodium hydroxide and approximately half sodium silicate. The water to binder ratio associated with the preferred embodiment is approximately 0.35-0.45.

In association with the preferred embodiment, the method of manufacturing the carbon-sequestering geopolymer concrete composition 100 comprises first preparing a dry mixer blend. The dry mixer blend comprises ground granulated blast furnace slag, magnesium oxide powder, and calcium oxide powder (Step 1).

Concurrently, an alkali activator solution is prepared by dissolving sodium silicate and sodium hydroxide in water (Step 2).

Next, mixing of the full concrete composition 100 commences by first introducing coarse aggregates followed by sand into a concrete mixer (Step 3).

The previously prepared dry mixer blend is then gradually incorporated while mixing proceeds to ensure uniform distribution of the ground granulated blast furnace slag, magnesium oxide powder, and calcium oxide powder throughout (Step 4).

With mixing ongoing, the alkali activator solution is slowly introduced to initiate dissolution and geopolymerization reactions between the dry mixer blend and the aggregates (Step 5).

Dried algae powder is subsequently added as the final dry ingredient to supplement the binder matrix (Step 6).

Thorough mixing continues for 10-15 minutes to fully disperse all constituents and prevent segregation (Step 7).

Immediately after concluding mixing, the fresh concrete is promptly poured into prepared molds, taking care to minimize air gaps that could compromise strength (Steps 8-9).

Ideally, the filled molds should be cured at 20-25 °C for the first 24-48 hours to optimize early strength development as geopolymerization reactions proceed (Step 10).

After demolding, the concrete is estimated to fully cure in 28 days, achieving higher durability and compressive strength compared to conventional concretes.

Globally, hundreds of millions of tons of industrial byproducts are produced each year. The vast majority end up piled in landfills due to lack of reuse applications, taking up scarce landfill volume while their chemical potential remains untapped. However, when properly processed with alkali solutions, these geopolymer precursors can readily transform into reactive binders ideal for concrete manufacturing. Their innate chemical properties allow for rapid setting, accelerated curing times, and high early strength development compared to traditional concrete.

Beyond reusing waste, geopolymers offer additional advantages over Portland cement for eco-friendly construction. The production of Portland cement requires heating calcium carbonate to extremely high temperatures, resulting in the release of massive amounts of CO2. Geopolymers, in contrast, utilize waste material that has already undergone high temperature processing during initial industrial manufacturing. This eliminates the need for additional heating, curtailing further CO2 emissions. Consequently, using industrial byproduct geopolymers rather than Portland cement reduces the carbon footprint of concrete by approximately 80%.

The abundant global supply and waste reduction benefits of repurposing industrial byproducts enables massive scalability using geopolymer binders for concrete manufacturing. And the improved curing performance facilitates faster construction compared to traditional concrete. This makes geopolymer-based concrete an ideal replacement for emissions-intensive Portland cement applications.

The geopolymers used in association with embodiments of the invention include slag, fly ash class C or class F, and/or silica fume. In association with various embodiments, the relative ratios of the different geopolymers can be adjusted based on availability and cost.

In an embodiment of the invention, the geopolymer utilized comprises slag, for example ground granulated blast furnace slag. Ground granulated blast furnace slag is a byproduct of iron production from iron ore and other iron bearing materials. Using slag as a geopolymer precursor takes advantage of its latent hydraulic properties and provides a productive reuse for this industrial waste product. Slag-based binders react readily with alkali solutions, generating rapid strength development and accelerated curing times that can improve construction schedules. They also produce very durable concrete. However, slag availability may be geographically restricted based on proximity to iron production facilities. In some embodiments, an alternative geopolymer to slag may be utilized, as transport costs may be high in regions distant from slag sources.

In an embodiment of the invention, the geopolymer utilized comprises fly ash, for example Class C or Class F fly ash. Class C fly ash results from burning subbituminous coal or lignite. It has self-cementing properties in addition to pozzolanic qualities when combined with activators. This allows class C fly ash concretes to gain strength rapidly. Using class C fly ash provides a productive reuse for this abundant waste product and reduces landfill waste volumes. However, variable compositions in class C ash supplies can lead to inconsistent performance. In some embodiments where concrete strength is prioritized, an alternative geopolymer to class C fly ash may be preferable to utilize. Strict quality control testing is needed to ensure adequate reactivity and concrete strength.

Class F fly ash is a byproduct of burning anthracite or bituminous coal. It has mostly pozzolanic properties requiring activation to contribute to concrete strength. While class F ash on its own reacts slower than slag or class C ash, blending class F ash with other geopolymer precursors can provide an economic binder option. It also greatly reduces industrial waste. However, class F ash has lower innate reactivity requiring higher activator levels. In some embodiments where rapid setting times are prioritized, an alternative geopolymer to class F fly ash may be preferable to utilize. Concrete setting time may extend using high volumes of class F ash unless mix designs are precisely calibrated.

Silica fume is a byproduct of producing silicon or ferrosilicon alloys. It is very reactive pozzolan when used with alkaline solutions. Silica fume significantly improves concrete strength, permeability, and durability. However, in some environments, silica fume is not widely available and has higher cost compared to other geopolymer precursors. This limits feasibility for use as the primary binder at high replacement levels in association with some embodiments. But supplemental additions of silica fume can optimize performance.

### Sand Aspects

In association with the preferred embodiment, sand plays an important role in the disclosed concrete mixture as a fine aggregate that improves cohesion and infills space between larger aggregates. The present inventor has recognized that the quality and properties of the sand used strongly influence fresh concrete workability as well as hardened strength and durability.

In the preferred embodiment, the sand has a grading zone of less than 2.5 mm and be comprised of strong, hard, durable particles that are free of salts, clay, loam, and organic impurities. Both natural and manufactured sands can produce suitable performance if properly washed, graded, and tested to ensure optimal purity and particle size distribution.

The present inventor has recognized that in association with embodiments, angular, crushed sand particles with rough surface textures provide superior mechanical keying between binder paste and aggregates compared to smooth, rounded grains. However, highly angular particles can also reduce workability. Natural sand deposits with semi-angular shapes balanced with some rounded particles offer a favorable compromise. Sieve analysis should be performed per ASTM C136 to quantify particle size variation, guide necessary wash grading, and identify potential deficiencies for a given sand supply.

In addition to mechanical and chemical purity associated with the preferred embodiment and the associated methods of production, the sand mineralogy and reactivity is assessed when specifying sand for the geopolymer concrete 100 described herein. Certain minerals can impact the alkalinity and setting reactions. Silica sands are generally compatible, while carbonate-based and feldspathic sands may react undesirably with activators. Petrographic examination provides valuable data for evaluating sand mineral suitability with the binder system.

The present inventor has recognized in association with the preferred embodiment that with careful control of sand purity, grading, and mineralogy coupled with adjustments in activator parameters, the disclosed composition offers wide flexibility regarding locally available and cost-effective sand supplies. Testing of multiple candidate sands is recommended to optimize quality, concrete performance, and eco-friendly production.

### Coarse Aggregates (Gravel or Crushed Stone) Aspects

In association with embodiments of the invention, coarse aggregates in the form of gravel or crushed stone serve as inexpensive fillers that also greatly impact fresh and hardened concrete properties. Gravel decreases drying shrinkage while improving strength and long-term durability associated with embodiments of the concrete.

High quality gravel has strong, durable, crushed rock particles free of clay, salts, and organic matter. Preferred types of rock include granite, quartzite, basalt, limestone, and durable sandstone. In association with the preferred embodiment, the crushing process should produce rough, angular pieces with fractured faces to enhance mechanical bonding within the concrete matrix.

Washed gravel grading sizes should range from 4 mm up to a maximum size of 20 mm in association with the preferred embodiment. The present inventor has recognized that larger aggregates can hamper workability and consolidate poorly during placement. Sieving analysis per ASTM C136 may determine particle size distribution to blend and confirm suitable grading in association with embodiments. Uniformly graded aggregates with a wide distribution of sizes generally produce optimal packing density and concrete performance in association with the preferred embodiment.

As in association with the sand specification in an embodiment, the mineralogy and chemical purity of coarse aggregates selected must also be vetted for compatibility with the geopolymer binder system in the preferred embodiment. Certain minerals may react adversely with the alkaline activators, while organics or salts can inhibit setting. Testing and analysis provides guidance for evaluating aggregate suitability and minimizing incompatibilities.

With aggregate sources varying regionally, testing multiple candidate gravels allows customizing for local availability and cost-effectiveness while maintaining quality standards in association with various embodiments. Optimized aggregate selection and mixing enables the geopolymer concrete 100 to achieve exceptional strength, longevity, and carbon impact reduction in sustainable infrastructure applications in association with various embodiments.

### Water Aspects

While water serves as an essential component to enable workability and curing reactions in all concretes, its quality and properties significantly influence the behavior of geopolymer mixtures in the fresh and hardened state. Control of water chemistry and impurities is crucial for performance in association with the preferred embodiment.

Ideally, the mixing water should be clean, potable fresh water free of oils, sugars, acids, alkalis and organic substances in association with the preferred embodiment. The present inventor has recognized that the presence of organics can inhibit setting or reduce concrete strength. Water high in mineral content can interfere with dissolution and polycondensation reactions needed for geopolymerization and hardening. Such effects underscore the importance of starting with high purity water in association with the preferred embodiment of the invention.

In addition to minimizing organics and dissolved solids, the source water pH, hardness and chloride ion content is carefully regulated in association with the intended method of manufacture. High pH levels introduce excess hydroxyl ions that impede polycondensation. Water hardness affects setting time, while chlorides may corrode reinforcing steel, which may play an important role in association with applications of embodiments of the invention such as in buildings and in roads. Specifying water with near neutral pH, low hardness, and chloride concentrations below 500 ppm ensures sound performance in association with the preferred embodiment.

Though many sources may be locally available, the present inventor has recognized that municipal drinking water supplies typically offer the best economics and consistency for meeting the stringent purity and composition needs of geopolymer concrete 100 on commercial scale. Adjustments to the activator solutions can further offset minor impurities when high quality fresh water is used as the baseline mixing medium in varying embodiments.

### Algae Aspects

In association with the preferred embodiment, dried marine saltwater algae powder is a critical component in the carbon-absorbing geopolymer concrete mixture. The algae acts as a carbon sink during the curing process, enabling significant absorption of CO2 from the surrounding air, as represented in FIGS. 1 & 2.

The dried marine saltwater algae powder algae powder acts as a carbon sink through natural chemical binding of CO2 within its cell wall structures. Key components that enable this CO2 absorption are calcium ions, magnesium ions, and alginate polymers contained within the algal cell walls.

As the concrete 100 cures, the dried marine saltwater algae powder algae powder rehydrates and partially dissolves, releasing calcium and magnesium ions along with alginate polymer chains. These ions and polymers are able to bind and chemically react with CO2 molecules that diffuse into the curing concrete from the surrounding air, as represented in FIGS. 1 and 2.

Specifically, in association with the preferred embodiment, the chemical reactions that occur during the concrete 100 curing process are:
Ca²⁺+CO2->CaCO3
Mg²⁺+CO2->MgCO3

In these reactions, the divalent calcium ions (Ca²⁺) and magnesium ions (Mg²⁺) released from the marine saltwater algae powder react with dissolved atmospheric CO2 to form solid calcium carbonate (CaCO3) and magnesium carbonate (MgCO3) particles. These carbonate compounds are stably integrated into the concrete matrix, locking in the absorbed CO2.

In addition, the alginate polymers released from the marine saltwater algae powder can bind CO2 through formation of carbamate crosslinks. The alginate acts as a scaffold helping to convert absorbed CO2 into solid carbonate forms.

The combined effect of the algae-derived calcium, magnesium, and alginates is to chemically bind significant quantities of atmospheric CO2 as the concrete cures, absorbing it into the concrete product and achieving a carbon-negative impact.

The dried marine saltwater algae powder is produced through harvesting of marine macroalgae, which is then dried and milled into a fine powder. Species from red and brown algae groups are preferred, such as Laminaria, Ascophyllum, Sargassum, and Fucus species.

These algae species are abundant and fast growing, making them excellent candidates for sustainable harvest. The cell walls of brown and red algae contain abundant calcium and magnesium ions which react with atmospheric CO2 as the concrete cures to form stable carbonate compounds, locking away the captured carbon in the concrete matrix.

Using algae rather than seawater provides additional benefits in association with the preferred embodiment. The high concentrations of reactive calcium and magnesium in dried marine saltwater algae powder allows for a smaller component ratio to be used in the concrete mix compared to seawater solutions. This reduces transportation costs and logistical challenges with integrating seawater, which would need to be sourced from coastal areas. Therefore, significant logistical and transportation impediments are reduced in association with embodiments of the invention.

The present inventor has recognized that using dried marine saltwater algae powder in the formulation associated with embodiments of the invention offers important advantages compared to seawater-based approaches to CO2-absorbing concrete. For example, algae cell walls contain very high concentrations of calcium, magnesium, and alginate polymers which capture CO2 as the concrete cures. The dried algae powder provides a dense, concentrated source of these reactive minerals. Seawater on the other hand is quite diluted, requiring much larger volumes of water to contribute enough calcium, magnesium and other salts to enable meaningful levels of CO2 absorption. Collecting and transporting these large volumes of seawater poses major logistical challenges and costs, especially for inland construction sites far from coastal access.

Moreover, the transportation costs and logistical barriers associated with using seawater in association with are avoided by using shelf-stable, easily transportable marine saltwater algae powder. Only small volumes of dried marine saltwater algae powder are needed to provide abundant CO2 capturing minerals. The marine saltwater algae powder's high concentration factor and stability for storage and transport provide key advantages over seawater by enabling affordable inland distribution.

Further, the drying process used to create the marine saltwater algae powder concentrates and activates the cell wall minerals to be highly reactive for binding atmospheric CO2. The drying also collapses the cell structures to facilitate rapid water permeation when rehydrated in the curing concrete, further enhancing diffusion of CO2. In contrast, seawater relies on natural diffusion of CO2 into stagnant water pockets, severely limiting absorption rates. The processed marine saltwater algae powder thus enables more efficient, higher levels of CO2 absorption during concrete curing.

Additionally, marine saltwater algae have evolved complex cell wall structures that are optimized to thrive in ocean conditions, with high salt-tolerance and more robust CO2-binding capabilities. The present inventor has recognized that this provides a key benefit in association with the preferred embodiment of the invention. These adaptations provide significant performance benefits over the use of freshwater algae in carbon-absorbing concrete. Marine saltwater environments shape the algae to be extremely effective carbon sinks.

Finally, mass algae farming via sustainable aquaculture provides a scalable, renewable supply that can be harvested without depletion of ocean ecosystems. Seawater-based approaches have far more limited availability. The continual cultivation of fast-growing marine algae enables the production of algae powder for CO2-absorbing concrete on an industrial scale.

Further, the present inventor has recognized the advantages of using marine seawater algae over freshwater algae in association with the preferred embodiment, in that freshwater algae species would absorb less CO2 compared to marine algae due to differences in cell wall structure and ion concentrations. Marine algae have adapted to the higher salinity ocean environment which provides more abundant ions for CO2 capture during curing.

Pre-drying the algae through solar or low-temperature drying methods into marine saltwater algae powder further enhances the reactive capabilities of the algal cell wall components, beneficial to embodiments of the invention, by enabling higher CO2 absorption rates as the concrete cures.

### Production Process

In association with the preferred embodiment, the carbon-absorbing geopolymer concrete 100 is produced through the following steps:

### Mixing the Coarse Aggregates While Dry:

In association with an embodiment, dry mixing the sand and gravel aggregates first serves several important purposes in the production process. Blending these major concrete ingredients while dry promotes uniform distribution within the particle mass before introducing water and binders. This improves consistency. Dry aggregating mixing also enables aggregate particle coating analyses to be conducted per ASTM C1260. Coating testing determines if the sand proportion effectively fills voids and encapsulates the gravel pieces without deficits or excess. Adjustments to the aggregate ratios can then be made efficiently at this stage if needed to optimize consolidated packing density in the final concrete. Homogeneous dispersion of the aggregates ahead of water addition eliminates localized variability that can occur when mixing all ingredients together from the start. Uniform aggregate distribution is critical for the concrete to achieve consistent strength and performance. Dry mixing just the sand and gravel thus allows quality control checks that ensure ideal aggregate proportions prior to committing the full batch.

### Adding the Blended Geopolymer Binder Components:

In association with an embodiment, adding and dry blending the geopolymer binder components after initial aggregate mixing allows even distribution of the slag, fly ash, and silica fume within the concrete dry ingredients. Uniform dispersion is important to maximize reactive surface area and ensure consistent reactivity of the precursor materials. Dry incorporation also enables sampling and testing to confirm composition ratios and adequate blending quality before wetting the batch. For example, samples could be examined per ASTM C136 to check particle size distribution and assess the need for any binder adjustments. Keeping the binders dry facilitates changes or corrections. Even minor segregation of binder ingredients can lead to performance variations in the final concrete. Thorough dry blending is thus an essential step to homogenize the full complement of dry constituents (aggregates and binder) ahead of alkali activator addition to lock in consistent geopolymer performance.

### Subsequently Adding the Dried Algae Powder to the Aggregates and Geopolymer Binder Components:

In association with embodiments, adding the dried marine saltwater algae powder as the final dry ingredient ensures it mixes efficiently with the other components while still dry. Algae powder is lightweight and can be prone to dusting. Incorporating it last when the other heavier aggregates and geopolymer binders have already been blended allows the algae to disperse and become embedded within the particle mixture without significant losses. Keeping the algae dry also prevents clumping or agglomeration into masses that resist separation and uniform blending. Dry homogeneous mixing is critical to distribute the microalgal powder so it can interact evenly across the binder phase and aggregates when water is introduced. This facilitates optimal formation of algal biomass-mineral composites during curing. Even minor inconsistencies in algae dispersion can lead to strength and performance variations. Adding the dried algae last when the other dry concrete constituents are already thoroughly mixed prevents segregation and ensures consistent composite properties after hardening.

### Slowly Incorporating Water While Mixing to Achieve a Workable Concrete Consistency:

In association with embodiments, water addition and mixing is a critical phase defining the behavior and properties of the fresh geopolymer concrete 100. Water initiates dissolution of the binder components and allows formation of a workable matrix for placement and consolidation. However, excessive water reduces strength. The mixing water must be added gradually and carefully controlled to achieve optimum consistency without overdosing. Adding water slowly while the mixer runs allows the concrete to blend thoroughly so water penetrates all ingredients without flooding localized areas at risk for overwatering. Controlled water addition also enables the concrete consistency to be continuously evaluated as more water is introduced. Mixing continues with small measured water increments until the concrete reaches the targeted level of workability for the application without compromising the water-binder ratio. Adjustments can be made interactively to achieve the design specification. This allows customization across batches for realistic variability between constituent materials while enabling consistent performance targets. Careful water addition and mixing provides the essential quality control point to strike the needed balance between concrete workability and final strength.

Pouring the Concrete Mixture into Molds or Forms for Casting:

In association with embodiments, pouring the carbon-absorbing geopolymer concrete mixture into molds or forms is a critical step for proper casting and curing of the material. Care must be taken to maintain a continuous pour flow without interruption which could cause localized setting within the forms prior to finishing. The high heat generation associated with geopolymerization reactions necessitates coordination of pour planning and sequences to avoid excessive heat concentrations. Formwork and reinforcement requirements may also require adjustments from traditional portland cement concrete designs to account for the unique properties of the geopolymer matrix. Testing should guide specification development to optimize mixture proportions and placement procedures for the intended application and curing conditions. With appropriate handling, the reactive properties of the concrete that enable enhanced carbon mineralization can be leveraged for casting of structural and durable infrastructure elements.

When pouring the carbon-absorbing geopolymer concrete 100 for building construction applications such as those depicted in FIGS. 1 and 2, the mixture can be cast into forms erected onsite to mold walls or structural elements per the project plans. The reactive properties of the concrete mixture necessitate continuous flows during pouring to prevent setting prior to consolidation and finishing within the forms. Multi-yard buckets raised by tower cranes may be used to convey and distribute the concrete to appropriate locations without interruption. The higher heat generation associated with geopolymerization reactions compared to traditional portland cement dictates additional care when planning pour sequences to avoid excessive heat buildup within any given formwork section that could cause cracking.

For road and sidewalk construction requiring reinforcement, the geopolymer concrete 100 can be poured over rebar mats laid over compacted grade in coordinated blocks matching pour sequences to traffic access needs. The concrete would then be finished to specified highway profiles. Rebar spacing and concrete cover thickness may require adjustment from traditional designs to account for the unique properties of the geopolymer matrix. Test pours should be performed to optimize placement procedures when using the concrete for transportation department projects.

When pouring the geopolymer concrete 100 for sidewalk or flatwork applications, such as that depicted in FIG. 1, the same basic principles apply in terms of continuous flows from mixers or buckets to avoid setting prior to screeding and finishing. However, the smaller volumetric flow rates enable direct chute discharges from portable mixers positioned proximate to the targeted placement area. The higher heat of hydration requires pour planning coordination to sequence progressive linear sections accordingly. The environmental exposure conditions associated with exterior hardscapes may also dictate adjusted mixture proportions to achieve required performance.

Allowing an initial hardening and drying process during which the marine saltwater algae powder absorbs CO2 directly from the air through natural chemical reactions with the geopolymer compounds.

In association with embodiments, allowing the freshly poured geopolymer-algae concrete to undergo initial hardening enables unique carbon mineralization processes. As the alkaline activation reactions proceed to set the binder matrix, the incorporated algal biomass provides reactive sites to facilitate additional carbonation curing. The algae contain organic compounds and functional groups that can bond and stabilize atmospheric CO2 through natural chemical interactions with the geopolymeric gel phases forming in the matrix pore structure. This complementary curing mechanism allows the concrete to directly absorb and mineralize carbon dioxide from the surrounding air.

The present inventor has recognized that letting this initial carbonation process occur without disturbance accelerates strength buildup in the material. The additional CO2 precipitation and carbonate formation provides supplementary binding and densification that supplements the geopolymerization polymer crosslinking. This carbon-enhanced curing regime enhances durability while progressively removing CO2 from the environment. Furthermore, the algal components help trap the mineralized carbon in a stable bio-composite, preventing re-release of the greenhouse gas. Allowing this in situ carbon mineralization to initially advance before moving or exposing the freshly cast concrete elements enables maximum carbon uptake.

Timing this initial curing period requires balancing early strength gain and carbonation against construction scheduling constraints. Testing can help characterize these competing dynamics and define an optimal initial hardening duration before demolding, transport, or finishing procedures are conducted. This demonstrates the importance of aligning project specifications and logistics to take full advantage of the carbon absorption capacities intrinsic to the algae-bearing geopolymer concrete 100. The geopolymer concrete 100 can be further finished and processed as per standard concrete methods once initially hardened and cured.

Continuing Absorbing of Atmospheric Carbon Dioxide Through Ongoing Reactions with the Algal Components Over the Concrete's Service Life:

In association with embodiments, even after the initial curing stage, the algae embedded within the hardened geopolymer concrete 100 matrix provide an avenue for continued carbon mineralization over time. The algal cell structures and biomolecules maintain carbon-sequestering function for an extended duration by enabling ongoing chemical interactions with CO2 diffusing into the concrete from the surrounding environment.

This persistent carbon absorption capacity stems from the unique bio-receptivity of algal compounds to bond with atmospheric carbon dioxide. As CO2 permeates the concrete, the algal components facilitate precipitation and stabilization of calcium carbonate deposits that incrementally fill micropores within the binder matrix. This self-replenishing capacity for carbon mineralization leads to excellent in-service durability while progressively extracting CO2 from the atmosphere.

Engineering the geopolymer-algae concrete system to optimize this continuing carbon sequestration pathway allows infrastructure elements to act as durable carbon sinks over their lifetime. While the absorption rate tapers, the cumulative CO2 removal can be substantial. Specifying higher algae content may enhance ongoing carbonation capacity depending on application constraints. Regardless, the algae-bearing geopolymer concrete 100 demonstrates persistent carbon mineralization translating to reduced atmospheric greenhouse gas levels over time.

### Chemical Reactions

In association with embodiments, and especially during the curing process, the following chemical reactions occur which enable CO2 capture from the air into the concrete:
CaO+CO2->CaCO3
MgO+CO2->MgCO3

The calcium oxide and magnesium oxide are reactive components provided by the geopolymers and algae powder. They undergo carbonation reactions with atmospheric CO2 to form stable carbonates which are integrated into the concrete structure.

The geopolymeric binder and algal components in the carbon-mineralizing concrete in embodiments provide reactive substrates to facilitate carbon dioxide capture from the air through carbonation. As CO2 diffuses into the pore network during initial curing, key oxides drive mineral carbonate formation:

Calcium oxide (CaO)—Originating from the algae/biomass ash and supplementary cementitious materials in the geopolymer, CaO reacts with absorbed CO2 to form calcium carbonate (CaCO3). This stable carbonate integrates into the binder matrix, supplementing the polymer structures.

Magnesium oxide (MgO)—Similarly, MgO phases in the algal ash and geopolymer constituents carbonate upon exposure to CO2, forming magnesium carbonates (MgCO3). These carbonates contribute to binder consolidation while storing absorbed CO2.

By providing reactive CaO and MgO precursor sites throughout the concrete mixture, the algae and geopolymeric compounds facilitate in situ carbon mineralization. The resulting carbonates lock in absorbed CO2 while enhancing matrix cohesion. This self-driven curing mechanism is central to capturing airborne CO2 and embedding it within the robust concrete structure.

Optimizing the blend of algae, geopolymers, and supplementary cementitious materials can maximize CaO and MgO availability in various embodiments. More of these reactive oxide phases promotes additional carbonate precipitation and CO2 uptake capacity. This empowers durable concrete elements to act as carbon sinks during service by leveraging intrinsic mineral carbonation reactivity.

Optimizing the geopolymer-algae concrete composition 100 to maximize carbon mineralization potential can follow several approaches in association with various embodiments. Increasing the algae content used as a supplementary cementitious material provides more reactive calcium oxide (CaO) and magnesium oxide (MgO) upon combustion of the biomass.

With higher concentrations of these oxides distributed throughout the binder matrix, additional carbonation sites are available as atmospheric carbon dioxide permeates into the pore structures of the curing concrete. More CaO and MgO facilitates further carbonate precipitation to lock in the absorbed CO2.

Additionally, the formulation of the geopolymeric source materials can be tuned to offer tailored CaO, MgO and other oxide contents. Certain natural pozzolans or slag-based precursors can provide reactive components that supplement the algae-derived phases. This allows the alkali-activated aluminosilicate chemistry to be optimized to impart mineral carbonation capacity beyond the algal biomass alone.

Incorporating interground limestone powder is another route to directly introduce supplementary CaO that enables further carbonation upon exposure to CO2. Optimizing the fineness and dosage of limestone additions in context of the full binder blend promotes additional carbon dioxide uptake driven by the added oxide content. Interground limestone powder would be more ideally incorporated into the geopolymeric source materials rather than the coarse aggregates when aiming to optimize carbon mineralization in the geopolymer-algae concrete system.

Adding fine limestone powder directly to the geopolymeric precursor allows dispersion throughout the binder matrix as it cures. This enables abundant calcium oxide reactivity that facilitates carbonation upon exposure to CO2 diffusing into the concrete. Uniform distribution of the limestone-derived CaO throughout the binder phase provides consistent carbonation potential.

Therefore intergrinding limestone into the geopolymeric aluminosilicate precursors in association with an embodiment, along with the algae as supplementary cementitious material, allows reliable enhancement of carbon dioxide absorption during curing and beyond. The fine powder dispersion promotes accessible and evenly distributed CaO content, enabling consistent mineral carbonate formation as atmospheric CO2 permeates the concrete over time.

Furthermore, substituting dolomitic aggregates contributes both CaO and MgO into the geopolymer matrix by dissolution. With this added source of oxides dispersed throughout the binder via the aggregates, supplementary mineral carbonation sites are provided to facilitate greater CO2 absorption.

These compositional modifications gear the hybrid geopolymer-algae concrete system to offer abundant CaO and MgO availability that drives more extensive carbonate formation. By aligning the complementary reactivities across algae, geopolymeric and cementitious components, the carbon dioxide sequestration potential reaches full utilization. This allows durable infrastructure elements to maximize service life while acting as carbon sinks.

In an example, an idealized geopolymer-algae concrete blend as an embodiment of the invention for maximized carbon mineralization could comprise:
65% coarse and fine aggregates (with 30% dolomitic sand)
20% alkali-activated slag and metakaolin geopolymeric binder
10% interground limestone powder
5% algal biomass ash as supplementary cementitious material

This exemplary formulation provides an optimal ratio of components to facilitate abundant carbon dioxide uptake during curing and beyond. The dolomitic sand contributes reactive MgO and CaO upon dissolution into the geopolymer matrix, while the algae and limestone powder both supplement additional oxide content dispersed throughout the binder.

With plentiful CaO and MgO availability, carbonation potential is maximized as atmospheric CO2 diffuses into the concrete over time. This drives extensive precipitated carbonate formation to stably capture the absorbed CO2. Meanwhile, the balanced blend of slag and metakaolin-based geopolymer binder offers a robust crosslinked matrix to consolidate the developing carbonate structures.

The result is durable concrete with maximized carbon sink characteristics, owing to optimized reactivity between algae, geopolymers, and supplementary cementitious constituents. Tuning the proportions of these complementary components allows the full CO2 mineralization capacity to be utilized for enhanced carbon-negative performance. This makes the material suitable for sustainable infrastructure applications requiring reliable carbon absorption.

In association with various embodiments of the invention, and to facilitate optimization of the associated components to the ideal ratios given variations in the inputs, multi-faceted analytical approach can systematically evaluate the carbon dioxide sequestration performance of optimized geopolymer-algae concrete formulations. In an example, gravimetric testing directly quantifies CO2 uptake through precise measurement of concrete sample mass change when subjected to controlled carbon dioxide exposure conditions. This determines the overall carbon mineralization capacity. Additionally, complementary thermogravimetric analysis provides insight into carbonate content and conversion efficiency by detecting the carbon dioxide released when heating concrete powder samples. Quantifying the liberated CO2 assesses how much has been stably incorporated into precipitated carbonate compounds. X-ray diffraction analysis of the concrete's mineral composition identifies which carbonate phases have formed during CO2 curing. Monitoring the intensity of carbonate diffraction peaks over time also reveals carbonation kinetics and mechanisms. Scanning electron microscopy offers visual microstructural verification of carbonate formation, distribution and integration within the binder matrix, indicating how the pore structure evolves as a result of CO2 absorption. Finally, Raman spectroscopy spatially maps carbonates precipitated throughout intact concrete samples by detecting associated molecular vibrations. The combination of these analytical techniques is intended to provide comprehensive evaluation of the dynamic carbon dioxide uptake and progressive carbonation processes occurring in optimized geopolymer-algae concrete as it acts as a carbon sink in association with various embodiments, and thereby facilitates comparison and optimization of the associated material inputs and ratios.

### 30-Story Building Example and Benefits

Particularly as urban centers continue expanding vertically, high-rise construction drives massive demand for concrete to build durable structures. For a typical 30-story building, over 158 million pounds of concrete are required just for the foundational and structural elements. Historically, this has relied solely on conventional Portland cement concrete mixes. However, the significant carbon footprint accompanying production of these standard concretes presents sustainability issues. To align large-scale buildings with global emissions reductions goals, alternative technologies are critically needed. Embodiments of the invention comprising the carbon-mineralizing geopolymer-algae concrete described herein may transform high-rise construction's impacts. By both minimizing the emissions associated with production and actively absorbing CO2 from the atmosphere, the technology offers carbon-negative performance unmatched by many traditional materials. For structures like 30-story towers requiring massive concrete volumes, these carbon-reducing attributes can drive measurable progress towards carbon-neutral built environments at urban scale.

Constructing a typical 30-story building requires a substantial amount of concrete, estimated at nearly 159 million pounds. Using conventional Portland cement formulations, the greenhouse gas emissions associated with concrete production for such a structure are significant. Each pound of standard concrete generates around 0.93 lbs. of carbon dioxide emissions during manufacturing. For the quantity needed for a 30-story high-rise, this equates to almost 148 million pounds of carbon dioxide emitted just from concrete production alone. Exemplary emissions associated with the construction of a 30-story building with prior art concrete formulations are:
Concrete needed: 158,800,000 lbs
CO2 per lb concrete: 0.93 lbs
Total CO2=158,800,000 lbs. concrete×0.93 lbs. CO2/lb concrete=147,700,000 lbs. CO2

Shifting to an building comprising an embodiment of the invention, with an optimized geopolymer-algae concrete blend as described herein, could dramatically curb adverse carbon impacts associated with building construction. With enhanced CO2 mineralization capacity compared to traditional concrete, the present inventor has recognized that an embodiment of the invention absorbs over 50 lbs. of carbon dioxide per cubic yard. Implementation of embodiments in the form of a 30-story high rise, wherein structural elements incorporate the carbon-sequestering concrete described herein, could feasibly sequester over 35 million lbs. of CO2. This offsets nearly a quarter of the emissions otherwise linked to conventional concrete production at such a scale. Furthermore, the present inventor has recognized that the incorporation of industrial byproduct geopolymers and algal biomass in association with various embodiments of the invention enables additional circular economy benefits.

Implementing carbon-negative geopolymer-algae concrete systems for such large buildings in association with embodiments of the invention exemplifies an impactful route towards sustainable construction. The improved carbon accounting compared to traditional materials helps address infrastructure's share of global emissions, while enhancing durability and mechanical performance over conventional concrete.

By incorporating industrial byproduct slag and fly ash as the geopolymeric precursors in association with embodiments of the invention, CO2 emissions during manufacturing are reduced to approximately 0.25 lbs. per pound of concrete. For a 30-story building's concrete needs, this approximately equates to under 40 million pounds of production emissions-far less than standard mixes (especially those incorporating Portland cement). Furthermore, the algal biomass content enables additional carbon dioxide absorption benefits.

As the geopolymer-algae concrete cures, the dried algae powder is estimated to sequester about 0.8 lbs. of CO2 per pound of concrete. At the scale of a 30-story building, the total absorption capacity of the concrete as an embodiment of the invention is over 127 million lbs. of CO2. In further optimized examples, this absorption may exceed the emissions, giving the material carbon-negative credentials.

Accounting for both the reduced emissions from geopolymer production and the enhanced algae-driven carbon uptake, the net CO2 impact for a 30-story building's concrete requirements would be an estimated 32 million pound deficit. Rather than contributing over 147 million pounds of emissions as prior art concrete incorporating Portland cement would, in embodiments of the invention, the geopolymer-algae concrete system could actively absorb up to 95 million more pounds of CO2 than it emits. This exemplifies the technology's potential to transform conventional concrete's carbon footprint for next-generation sustainable construction.

### Exemplary Implementation: Highway/Road Construction

Building extensive highway networks and urban road infrastructure necessitates substantial concrete usage, historically relying on conventional Portland cement. For example, a typical 4-lane, 1-mile highway stretch requires over 25 million lbs. of concrete for pavements and structures. At standard emissions rates, this concrete's production would generate nearly 24 million lbs. of carbon dioxide. By incorporating industrial byproduct geopolymers and algal additives, our novel concrete mix reduces the CO2 footprint of such road projects by over 80%. Enhanced carbon mineralization also enables the pavement to actively absorb ambient CO2 during service life. Implementing the technology across nationwide road construction would mitigate over many millions tons per year of CO2 emissions, supporting sustainability in infrastructure expansion.

The high compressive and flexural strengths of the carbon-absorbing concrete embodiments described herein also provide superior technical performance for roads and bridges compared to existing alternatives. This durability translates into extended service lifetimes with reduced maintenance frequency. The enhanced longevity and corrosion resistance ensures highway integrity is preserved for longer periods before repavement or reconstruction is needed. This creates additional savings in materials, costs and emissions over the full structure lifecycles.

### Exemplary Implementation: Sidewalk Construction

Sidewalks and walkways are prime candidates to incorporate the carbon-mineralizing concrete technology described herein. It is an embodiment of the invention to provide a sidewalk comprising the concrete described herein. Many millions of square feet of sidewalks are poured nationally each year, primarily using conventional concrete mixes. Adopting the geopolymer-algae concrete formulations as described herein for pedestrian infrastructure projects would significantly reduce CO2 emissions.

The typical sidewalk slab requires around 0.05 cubic yards of concrete per square foot laid. With an average thickness around 4 inches, the geopolymer-algae concrete mix described herein can be readily poured and finished using existing construction techniques. The present inventor algae additive also enhances the freeze-thaw resilience critical for concrete exposed to winter conditions. It is therefore an aspect of the invention to provide a sidewalk with enhanced freeze-thaw resilience comprising the concrete described herein.

In association with embodiments of the invention, over a typical 50-year service lifetime, each cubic yard of our geopolymer-algae concrete sidewalk slab sequesters up to 30 lbs. of ambient CO2. Widescale adoption in the United States of sidewalk embodiments of the invention could cumulatively remove over 120 million tons of CO2 from the atmosphere. This embodied carbon absorption combines with over 70% lower emissions during manufacturing compared to traditional mixes. The technology is thereby ideally suited to transform the environmental impacts of sidewalk construction.

With urban pedestrian infrastructure renewal projects ongoing year-round globally, specifying the concrete technology associated with embodiments in sidewalk construction can rapidly scale emissions mitigation across this sector. The present inventor has recognized that the ease of integration associated with embodiments of the invention with existing pouring and finishing equipment facilitates rapid adoption around sidewalks, walkways and related structures. This enables progressive built environment entities to cost-effectively tap into the preferred embodiment's immense carbon reduction opportunities.

A key aspect of embodiments of the invention is enabling the finished pedestrian infrastructure to persistently sequester carbon dioxide from the air during its service lifetime through ongoing mineralization reactions. This is achieved by incorporating 1-5% dried marine saltwater algae powder into the geopolymer-concrete mixture prior to pouring. As the concrete cures in the form of a sidewalk in association with an embodiment, components of the algae cell walls dissolve into the binder matrix, providing abundant calcium ions, magnesium ions and alginate polymer chains with high affinity for carbon dioxide. Over the estimated 50 year sidewalk lifetime, atmospheric CO2 is able to gradually diffuse into and permeate through the slab. During periodic wetting and drying cycles, this CO2 interacts with the algae-derived ions and polymers, undergoing natural carbon mineralization processes. The dissolved CO2 chemically precipitates into stable, insoluble solid carbonate compounds integrated within the concrete structure. These carbonate precipitates include calcium carbonate (CaCO3) and magnesium carbonate (MgCO3) particles that stably lock in the absorbed CO2 for extended timeframes, enabling persistent carbon sequestration over the full service duration.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents, including the inclusion of plural or singular aspects of the system otherwise than as described herein. It is intended that the following claims define the scope of the invention and that methods and structures within the scope of these claims and their equivalents be covered thereby.

1. A method of producing a carbon-sequestering concrete comprising:
mixing sand and gravel aggregates while dry;
adding and dry blending geopolymer binder components comprising at least one of slag, fly ash class C, fly ash class F, metakaolin, or silica fume;
subsequently adding dried algae powder after mixing the aggregates and geopolymer binder components;
slowly incorporating water while mixing to achieve a workable concrete consistency; and pouring the concrete mixture into molds or forms for casting.

2. The method of claim 1 further comprising allowing an initial hardening and drying process during which the algae powder absorbs carbon dioxide directly from the air through natural chemical reactions with the geopolymer compounds.

3. The method of claim 1 wherein the step of mixing sand and gravel aggregates enables analysis of particle coating to optimize consolidated packing density in the final concrete.

4. The method of claim 1 wherein the step of slowly incorporating water comprises controlled addition in measured increments to achieve a targeted level of workability without compromising a water-binder ratio.

5. The method of claim 1 wherein the step of pouring the concrete mixture comprises conveying the mixture to maintain a continuous pour flow without interruption to prevent localized setting prior to finishing.

6. The method of claim 1 further comprising finishing and processing the concrete after the initial hardening and curing process.

7. The method of claim 1 wherein the algae powder comprises dried, pulverized marine macroalgae.

8. The method of claim 7 wherein the marine macroalgae comprises at least one of Laminaria, Ascophyllum, Sargassum, and Fucus species.

9. A carbon-sequestering concrete composition comprising:
35-50% geopolymers comprising at least one of ground granulated blast furnace slag, class C fly ash, class F fly ash, metakaolin, or silica fume;
30-45% sand;
15-25% coarse aggregates comprising gravel or crushed stone;
5-10% water; and
1-5% dried marine algae powder.

10. The composition of claim 9, wherein the geopolymers comprise ground granulated blast furnace slag and metakaolin.

11. The composition of claim 9, wherein the geopolymers comprise class C fly ash.

12. The composition of claim 9, wherein the geopolymers comprise class F fly ash blended with at least one of ground granulated blast furnace slag, class C fly ash, metakaolin, or silica fume.

13. The composition of claim 9, wherein the sand has a particle size of less than 2.5 mm and angular crushed particles with semi-angular shapes.

14. The composition of claim 9, wherein the coarse aggregates have particle sizes ranging from 4 mm to 20 mm.

15. The composition of claim 9, wherein the dried marine algae powder comprises species from red and brown algae groups.

16. The composition of claim 15, wherein the dried marine algae powder comprises at least one of Laminaria, Ascophyllum, Sargassum, and Fucus species.

17. The composition of claim 9 further comprising interground limestone powder incorporated into the geopolymer binder at a ratio of 5-15% by weight.

18. The composition of claim 17 wherein the interground limestone powder has a particle size less than 100 microns.

19. The composition of claim 17 wherein incorporation of the interground limestone powder provides abundant calcium oxide reactivity throughout the binder matrix to facilitate additional carbon dioxide absorption during curing.

20. The composition of claim 9 wherein the coarse aggregates comprise dolomitic sand to contribute reactive magnesium oxide and calcium oxide to the geopolymer matrix upon dissolution, thereby providing additional carbon dioxide absorption capacity.

21. A carbon dioxide-sequestering concrete binder composition comprising:
one or more aluminosilicate source materials selected from the group consisting of ground granulated blast furnace slag, fly ash, metakaolin and silica fume;
an alkaline activator;
dried marine algae powder; and
optionally one or more supplementary cementitious materials.

22. A concrete composition for absorbing atmospheric carbon dioxide comprising:
coarse and fine aggregates;
15-30% of a geopolymer binder phase comprising aluminosilicate source materials and an alkaline activator;
1-10% dried marine algae powder;
5-15% of one or more supplementary cementitious materials selected from the group consisting of interground limestone powder and reactive aggregate materials; and
water.

23. A sidewalk comprising the carbon-sequestering concrete of claim 9.

24. The sidewalk of claim 23, having a thickness of 4 inches.

25. The sidewalk of claim 23, wherein the concrete has a freeze-thaw resilience to withstand winter conditions during its service lifetime.

26. The sidewalk of claim 23, configured to sequester carbon dioxide from the atmosphere over a service lifetime of at least 50 years.

27. The sidewalk of claim 26, configured to sequester up to 30 lbs of carbon dioxide per cubic yard of the concrete over the service lifetime.

28. The sidewalk of claim 23, wherein widescale adoption of the sidewalk enables cumulative removal of over 120 million tons of carbon dioxide from the atmosphere.

29. The sidewalk of claim 23, configured for construction using existing pouring and finishing equipment for pedestrian infrastructure.

30. A sidewalk comprising:
a geopolymer-algae concrete slab having a thickness of 4 inches;
wherein the slab is configured to sequester up to 30 lbs carbon dioxide per cubic yard of concrete over a 50 year service lifetime.

31. The sidewalk of claim 30 having freeze-thaw resilient characteristics.

32. A method of constructing and preserving the carbon-sequestering elements of a sidewalk comprising:
pouring a carbon-sequestering geopolymer-algae concrete mixture into forms erected on grade, wherein the concrete mixture comprises 1-5% dried saltwater marine algae powder into the geopolymer-algae concrete mixture;
finishing the concrete to achieve a 4 inch thickness concrete slab in the shape of a sidewalk segment;
allowing atmospheric carbon dioxide to permeate into and diffuse through the concrete slab over time:
facilitating carbon mineralization reactions between the atmospheric carbon dioxide and algae-derived calcium ions, magnesium ions, and alginate polymers released during periodic wetting and drying cycles; and
precipitating and integrating stable calcium carbonate and magnesium carbonate compounds into the concrete slab matrix, stably locking in the absorbed carbon dioxide over an extended duration.

33. A carbon-sequestering geopolymer concrete composition comprising:
30-50% ground granulated blast furnace slag as a geopolymeric binder precursor,
30-40% gravel as a coarse aggregate,
approximately 35% sand as a fine aggregate,
2-5% dried marine algae powder,
5-10% magnesium oxide powder,
5-10% calcium oxide powder,
approximately 5% sodium hydroxide and approximately 5% sodium silicate as an alkali activator,
wherein the composition achieves reduced carbon dioxide emissions compared to conventional concretes using traditional Portland cement.

34. The composition of claim 33, wherein atmospheric carbon dioxide is captured and mineralized by the integrated dried marine algae powder as the composition cures.

35. The composition of claim 33, having a water to binder ratio of 0.35 to 0.45.

36. A method of manufacturing the carbon-sequestering geopolymer concrete composition of claim 33 comprising:
(a) Preparing a dry mixer blend comprising the ground granulated blast furnace slag, magnesium oxide powder, and calcium oxide powder;
(b) Preparing an alkali activator solution comprising sodium silicate and sodium hydroxide dissolved in water;
(c) Introducing coarse aggregates and sand into a concrete mixer;
(d) Adding the dry mixer blend;
(e) Adding the alkali activator solution;
(f) Adding dried marine algae powder; and
(g) Mixing thoroughly to disperse components.

37. The method of claim 36, further comprising pouring the mixed composition into molds and curing at 20-25 °C for 24-48 hours.

38. The method of claim 37, wherein the composition achieves full cure in 28 days with enhanced durability and strength versus conventional concretes.
